(19) United States
(12) Patent Application Publication
(10) Pub. No.: US 2011/0015050 A1
(43) Pub. Date: Jan. 20, 2011

(54) TOOL MAGAZINE

(75) Inventor: Ryuei HAKAMATA, Niwa-Gun (JP)

Correspondence Address: BURR & BROWN, PO BOX 7068, SYRACUSE, NY, 13261-7068, US

(73) Assignee: Okuma Corporation, Niwa-Gun (JP)

(21) Appl. No.: 12/817,505

(22) Filed: Jun. 17, 2010

(30) Foreign Application Priority Data
Jul. 15, 2009 (JP) 2009-167070

(51) Int. Cl. B23Q 3/155

(52) U.S. Cl. 483/67

(57) ABSTRACT

A tool magazine includes: a rotary shaft; and a plurality of tool gripping members radially extending around the rotary shaft. The tool magazine is configured to transfer tools between the tool gripping members and a tool attachment portion of a machine tool. The plurality of tool gripping members are arranged such that two tool gripping members are at least partially adjacent to each other and disposed in different heights in a direction of the rotary shaft, so that a tool is transferred between one of the two tool gripping members and the tool attachment portion without interference of the tool attachment portion against a tool gripped by the other one of the adjacent tool gripping member.

This application claims the entire benefit of Japanese Patent Application Number 2009-167070 filed on Jul. 15, 2009, the entirety of which is incorporated by reference.

### BACKGROUND OF THE INVENTION

1. Field of the Invention

The present invention relates to a tool magazine provided on a machine tool such as a machining center.

2. Description of Related Art

As disclosed in Japanese Laid-open Patent Publication No. 06-218645, a conventional machine tool, such as a machining center, for processing a workpiece using a tool attached to a main spindle is provided with a tool magazine, in which a plurality of different kinds of tools can be stored. Tools can be exchanged between the tool magazine and the main spindle.

Herein, a general configuration of the tool magazine is explained with reference to FIGS. 4A and 4B. As seen in FIGS. 4A and 4B, a tool magazine 41 comprises a plurality of arms 42a, 42b radially provided around a rotary shaft (not shown). The arm 42a is capable of gripping a tool T1 having a small diameter, whereas the arm 42b is capable of gripping a tool T2 having a large diameter, while the tools T1, T2 being kept in parallel with the rotary shaft (i.e., in positions orthogonal to the arms). In this tool magazine 41, all the arms 42a, 42b are arranged in the same plane that is orthogonal to the rotary shaft. Therefore, as best seen in FIG. 4B, tool gripping positions where the arms 42a, 42b grip the tools T1, T2 are arranged on a line as viewed from a radial direction of the tool magazine 41.

However, if all the arms 42a, 42b are arranged in the same plane as in the case of the conventional tool magazine, it is necessary to provide a large space between adjacent arms 42a, 42b to avoid interference of the main spindle against the tool gripped by the adjacent arm during transfer of the tools. For this reason, the tool magazine 41 requires a large radius R2, which limits to reduce the size of the tool magazine 41.

In view of the above drawback of the conventional tool magazine, the present invention seeks to provide a tool magazine which can reduce the whole size of the device.

### SUMMARY OF THE INVENTION

In accordance with one aspect of the present invention, as embodied and described herein, there is provided a tool magazine which comprises: a rotary shaft; and a plurality of tool gripping members radially extending around the rotary shaft, and which is configured to transfer tools between the tool gripping members and a tool attachment portion of a machine tool, wherein the plurality of tool gripping members are arranged such that two tool gripping members are at least partially adjacent to each other and disposed in different heights in a direction of the rotary shaft, so that a tool is transferred between one of the two tool gripping members and the tool attachment portion without interference of the tool attachment portion against a tool gripped by the other one of the adjacent tool gripping member.

According to a preferred embodiment, the two adjacent tool gripping members may be at least partially overlapped with each other as viewed from the direction of the rotary shaft.

With the aforementioned configuration of the tool magazine according to the first aspect of the present invention, since two tool gripping members are at least partially adjacent to each other and disposed in different heights in a direction of the rotary shaft, the two tool gripping members can be positioned closer to each other while avoiding interference of the tool attachment portion against a tool gripped by the adjacent tool gripping member. Therefore, when compared with the conventional tool magazine where all the arms are arranged in the same plane that is orthogonal to the rotary shaft, even if the number of the arms is not decreased, the radius of the tool magazine can be decreased so that the size of the device can be downsized. Further, decreasing the size of the tool magazine can contribute to decreasing the production cost as well as improvement in workability such as assembling operation, maintenance operation, and conveyance operation.

Further, with the aforementioned configuration of the tool magazine according to the preferred embodiment of the present invention, since the two adjacent tool gripping members are at least partially overlapped with each other as viewed from the direction of the rotary shaft, the distance between the two adjacent arms can be further shortened. This can further decrease the size of the tool magazine.

### BRIEF DESCRIPTION OF THE DRAWINGS

The above aspect, other advantages and further features of the present invention will become more apparent by describing in detail illustrative, non-limiting embodiments thereof with reference to the accompanying drawings, in which:

FIG. 1 is a perspective explanatory view of a machine tool equipped with a tool magazine;

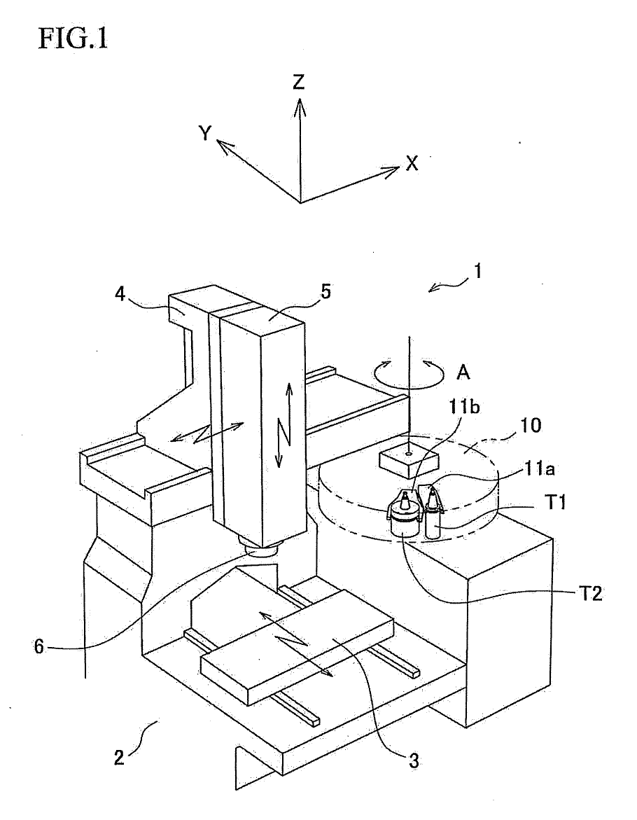

FIG. 2 is an enlarged perspective explanatory view of the tool magazine;

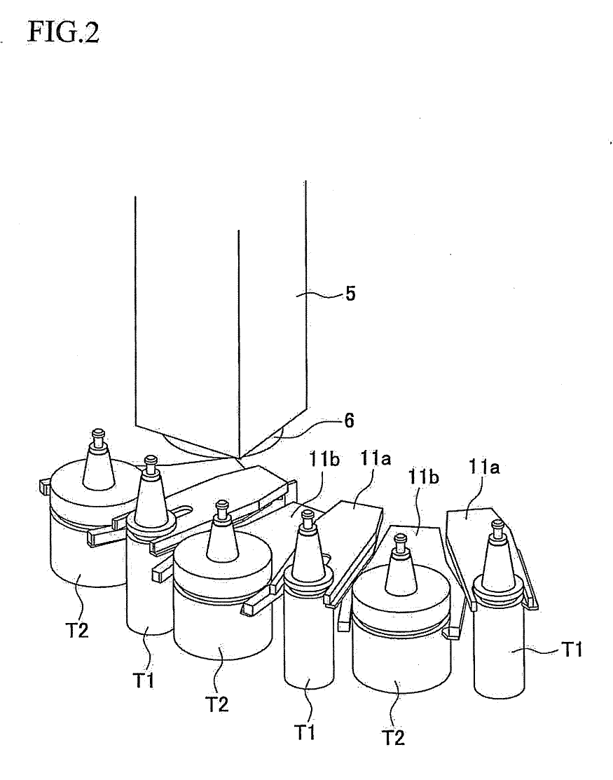

FIGS. 3A and 3B are partial explanatory views of the tool magazine, in which FIG. 3A is an explanatory view as viewed from a rotary shaft direction, and FIG. 3B is an explanatory view as viewed form a radial direction; and

FIGS. 4A and 4B are partial explanatory views of a conventional tool magazine, in which FIG. 4A is an explanatory view as viewed from a rotary shaft direction, and FIG. 4B is an explanatory view as viewed form a radial direction.

### DETAILED DESCRIPTION OF THE EXEMPLARY EMBODIMENTS

With reference to the accompanying drawings, a tool magazine according to one exemplary embodiment of the present invention will be described.

Reference number 1 denotes a machining center equipped with a tool magazine. The machining center 1 has a bed 2, a table 3 provided on the bed 2 and configured to be slidable in a Y-axis direction (i.e., front and rear direction), and a cross-feed slide 4 provided on the bed 2 and configured to be slidable in an X-axis direction (i.e., right and left direction) that is orthogonal to the Y-axis direction. Provided on a front face of the cross-feed slide 4 above the table 3 is a headstock 5 which is slidable in a Z-axis direction (i.e., up and down direction) that is orthogonal to the X-axis and the Y-axis. The headstock 5 includes a main spindle 6 at its lower surface. Further, at the right-hand side of the table 3, there is provided a tool magazine 10 for storing various tools T1, T2 configured to be attachable to the main spindle 6. The main spindle 6 is rotatable around a C-axis that is parallel to the Z-axis. Slide movements of the table 3, the cross-feed slide 4 and the headstock 5, the rotary movement of the main spindle 6, and a rotary movement of the tool magazine 10 to be described later are all controlled by a controller (not shown).

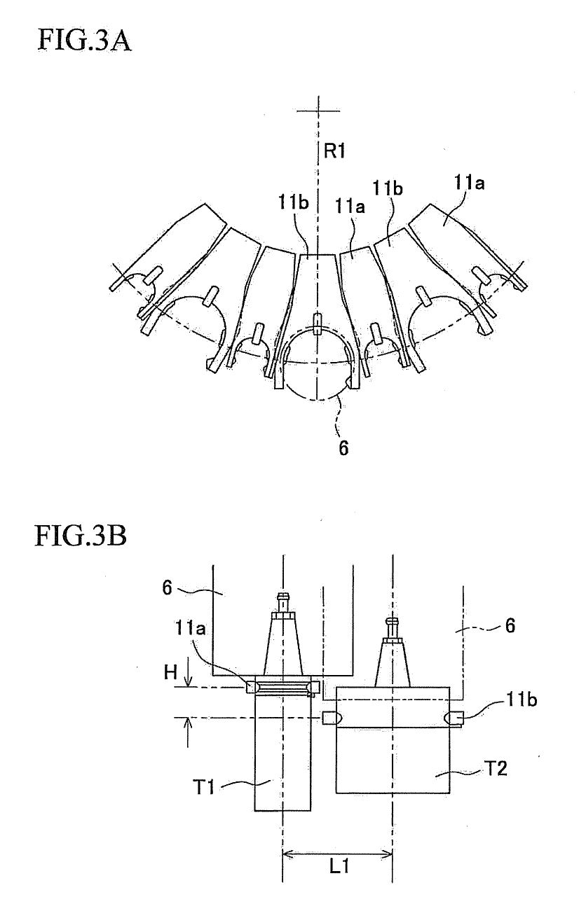

The tool magazine 10 comprises a rotary shaft (not shown) rotatable around an A-axis that is parallel to the Z-axis, and a plurality of arms 11a, 11b radially provided around the rotary shaft. The arm 11a is capable of griping a tool T1 having a small diameter, whereas the arm 11b is capable of gripping a tool T2 having a large diameter. The arm 11b has a larger width in a rotational direction when compared with the width of the arm 11a. A gripper is provided at a distal end of each arm 11a, 11b, which is configured to be open and closed so that, as with the conventional tool magazine, the tool T1 or the tool T2 is gripped in a position parallel to the rotary shaft. The arms 11a, 11b are arranged such that the arm 11a is positioned at a higher level in the direction of the rotary shaft and the arm 11b is positioned at a lower level in the direction of the rotary shaft while these arms 11a, 11b are at least partially overlapped with each other as viewed from the direction of the rotary shaft, so that the arms 11a, 11b are provided at different heights with respect to the rotational direction. Therefore, as viewed from the radial direction of the tool magazine 10, the gripping position of the arm 11a in the direction of the rotary shaft at which the arm 11a grips the tool T1 is different from the gripping position of the arm 11b in the direction of the rotary shaft at which the arm 11b grips the tool T2, and as best seen in FIG. 3B, there is a height difference H in level between these gripping positions. The distance between the arm 11a and the arm 11b is L1. It is noted that the tool T1 is attached to the main spindle 6 such that an upper end surface of the tool T1 lies in the same plane with a distal end surface of the main spindle 6, whereas the tool T2 is attached to the main spindle 6 in such a manner that an upper end surface of the tool T2 goes into the distal end surface of the main spindle 6. Further, it is noted that when the arms 11a, 11b grip the tools T1, T2, the amount of an upward protrusion from each of the arm 11a, 11b is different between the tool T1 and the tool T2.

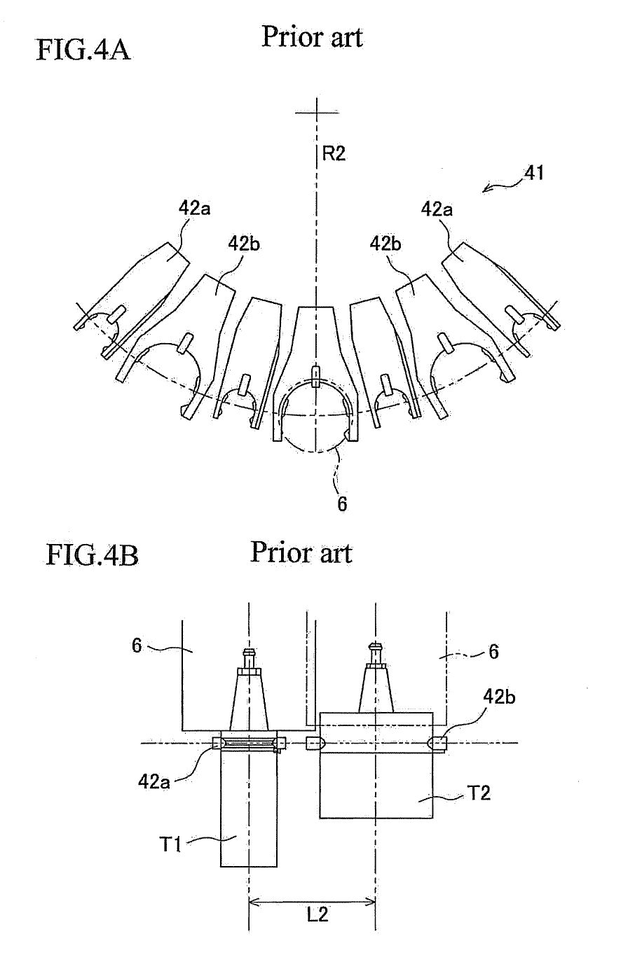

Accordingly, since the arm 11a and the arm 11b are arranged as described above and the protrusion in the tool T2 upwardly protruding from the arm 11b is positioned lower than that of the tool T1, even if a distance between the arm 11a and the arm 11b is set as the length L1 that is determined based on the diameter (i.e., size of the aim 11a) of the tool T1 and the size of the main spindle 6, interference between the main spindle 6 and the protrusion of the tool T2 can be avoided during transfer of the tool T1. On the contrary, according to the conventional tool magazine, in order to avoid interference between the main spindle 6 and the protrusion of the tool T2 during transfer of the tool T1, the distance L2 is required between the arm 42a and the arm 42b, which distance is determined based on the diameter (i.e., size of the arm 42b) of the tool T2 and the size of the main spindle 6. According to the tool magazine 10 in this exemplary embodiment, the distance L1 between the arms 11a, 11b can be shortened from the distance L2 between the arms 42a, 42b according to the conventional tool magazine 41, and the distance from the rotary shaft to the grippers of the arms 11a, 11b, namely, the radius R1 of the tool magazine 10 can be smaller than the radius R2 of the conventional tool magazine 41 as shown in FIG. 4A, in which all the arms are arranged in the same plane that is orthogonal to the rotary shaft without being overlapped with each other. It is to be noted that as viewed from the direction of the rotary shaft, the grippers of the anus 11a, 11b are positioned on the same circumference whose center corresponds to the rotary shaft. Further, the height difference H is determined so as to prevent interference of the main spindle 6 against the tool T2 gripped by the adjacent arm 11b during the transfer of the tool T1 between the main spindle 6 and the arm 11a.

According to the machine tool 1 equipped with the tool magazine 10 as described above, while a desired arm 11a (or 11b) is indexed into a predetermined exchanging position, the main spindle 6 is fed downward from above the exchanging position in a direction parallel to the rotary shaft, so that the tool T1 (or T2) can be transferred between the arm 11a (or 11b) and the main spindle 6. Since the height positions of the arms 11a, 11b are different in the direction of the rotary shaft, a feeding distance of the main spindle 6 varies depending on which arm is used for the transfer of the tool. Therefore, feeding distances of the main spindle 6 are set in advance in accordance with kinds of arms, and they are stored in the controller.

According to the tool magazine 10 as described above, in which a plurality of arms 11a, 11b are radially provided around the rotary shaft, since the arms 11a, 11b adjacent to each other in the rotational direction are disposed in different heights in the direction of the rotary shaft, the distance L1 of the two adjacent arms 11a, 11b can be shortened as compared with the distance L2 in the conventional tool magazine while avoiding interference of the main spindle 6 against the tool gripped by the adjacent arm during the transfer of the tool. Therefore, when compared with the conventional tool magazine where all the arms are arranged in the same plane that is orthogonal to the rotary shaft, even if the number of the arms is not decreased, the radius R1 of the tool magazine 10 can be decreased so that the size of the device can be downsized. Further, decreasing the size of the tool magazine 10 can contribute to decreasing the production cost as well as improvement in workability such as assembling operation, maintenance operation, and conveyance operation. This is particularly advantageous when the tool magazine 10 stores a tool T1 having a small diameter and a smaller amount of protrusion from the arm 11a, and a tool T2 having a large diameter and a large amount of protrusion from the arm 11b, and the downsizing of the tool magazine 10 can be achieved in the most efficient manner.

Additionally, since the adjacent arms 11a, 11b are arranged in different height positions in the direction of the rotary shaft and further the arms 11a, 11b are at least partially overlapped with each other as viewed from the direction of the rotary shaft, the distance between the arm 11a and the arm 11b can be further shortened. This can further decrease the size of the tool magazine 10.

Although the tool magazine according to the present invention has been described in detail with reference to the above exemplary embodiment, the present invention is not limited to the above specific embodiment and various changes and modifications, such as shapes or a geometrical arrangement of the arms, may be made without departing from the scope of the appended claims.

For example, the arms 11a, 11b are arranged at two different height levels including the upper level and the lower level in the direction of the rotary shaft. However, the arms may of course be provided at three or more different height levels. Further, although two kinds of arms are provided in the above exemplary embodiment including the arm 11a configured to grip the tool T1 having a small diameter and the arm 11b configured to grip the tool T2 having a large diameter, more than three kinds of arms may be provided. Also, only one kind of arm may be provided. To be more specific, if the same kind of arms grip the tools which are same in diameter but different in protrusion amount from the arm, the distance between the arms can be shortened as previously described in the above exemplary embodiment by providing the arms at different height positions in the direction of the rotary shaft. Further, even if the same kind of arms grip the tools having the same protrusion amount from the arm, the size of the tool magazine 10 can be downsized by the arrangement in which adjacent arms are at least partially overlapped with each other as viewed from the direction of the rotary shaft. Therefore, unlike the configuration of the above exemplary embodiment in which the height positions of the arm in the direction of the rotary shaft are changed in accordance with the kinds of arms, as a matter of course, the same kind of arms may be arranged at different height levels in the direction of the rotary shaft.

The amount of protrusion of the tool from the arm and/or the manner of attachment of the tools to the main spindle may be modified where necessary, and according to such modifications, the height difference H may be set so that the distance between the arms can be the shortest while taking into consideration that the main spindle does not interfere with adjacent tools or adjacent arms during the transfer of the tool. It is also possible to set the height difference H such that the tools can be transferred between the main spindle and the arms at the same height position of the distal end surface of the main spindle irrespective of which arm grips the tool.

Further, as described in the above exemplary embodiment, it is not necessary that the adjacent arms 11a, 11b are at least partially overlapped with each other as viewed from the direction of the rotary shaft.

Further, as long as some of adjacent arms, among all the arms provided in the tool magazine, are at least partially adjacent to each other and disposed in different heights in the direction of the rotary shaft, it is not necessary that all the arms are arranged as described in the above exemplary embodiment in such a manner that adjacent arms are disposed in different heights in the direction of the rotary shaft. Further, in the above exemplary embodiment, the arms are provided such that the gripers are positioned on the same circumference whose center corresponds to the rotary shaft. However, the present invention is not limited to this specific arrangement in which distal portions of all the arms are positioned on the same circumference. For example, a plurality of arms having different radial lengths may be employed.

Furthermore, in the above exemplary embodiment, each tool is gripped by the corresponding aim in a position parallel to the rotary shaft. However, the present invention is not limited to this specific configuration, and may be applicable to a tool magazine, in which tools are supported parallel to the radial direction extending from the center of rotation. It is also possible in this type of the tool magazine that the size of the device can be decreased.

In addition to the above, as a matter of course, the tool magazine according to the present invention is applicable to other machine tools other than one described in the above exemplary embodiment. Further, the tool magazine may be installed such that the rotary shaft thereof is positioned orthogonal to the main spindle.

What is claimed is:

1. A tool magazine which comprises:
a rotary shaft; and
a plurality of tool gripping members radially extending around the rotary shaft, and which is configured to transfer tools between the tool gripping members and a tool attachment portion of a machine tool,
wherein the plurality of tool gripping members are arranged such that two tool gripping members are at least partially adjacent to each other and disposed in different heights in a direction of the rotary shaft,
whereby a tool is transferred between one of the two tool gripping members and the tool attachment portion without interference of the tool attachment portion against a tool gripped by the other one of the adjacent tool gripping member.

2. A tool magazine according to claim 1, wherein the two adjacent tool gripping members are at least partially overlapped with each other as viewed from the direction of the rotary shaft.
